(19) United States
(12) Patent Application Publication
(10) Pub. No.: US 2014/0108922 A1
(43) Pub. Date: Apr. 17, 2014

(54) CONTENT LAYOUT DETERMINATION

(71) Applicants: Theo Gravity, San Jose, CA (US); Andres Garza, San Jose, CA (US)

(72) Inventors: Theo Gravity, San Jose, CA (US); Andres Garza, San Jose, CA (US)

(21) Appl. No.: 13/652,674

(22) Filed: Oct. 16, 2012

(51) Int. Cl. G06F 17/00

(52) U.S. Cl. 715/246

(57) ABSTRACT

A method for determining the placement of content on a page is provided. The method initiates with receiving a content feed, the content feed including one or more content data items. One or more content viewer modules are selected for inclusion in the page, each content viewer module configured to present a content data item on the page. One or more page layouts are determined, each page layout defining one or more placement slots for placement of the content viewer modules. The selected content viewer modules are fitted to the page layouts to identify a valid page layout which can simultaneously accommodate each of the content viewer modules. The valid page layout is populated by assigning the content viewer modules to the placement slots of the valid page layout and applying the assigned content viewer modules to one or more of the content data items of the content feed.

### BACKGROUND

1. Field of the Invention

The present invention relates to methods and systems for determining the layout of content on pages of an electronic publication.

2. Description of the Related Art

In recent years, tablet computing devices have gained popularity, providing a large touchscreen interface for intuitive input and interaction, and leveraging improvements in wireless connectivity. The increasing prevalence of tablet computing devices has fueled the rise of electronic publications, which are able to deliver rich media experiences to the end user by virtue of the flexible format afforded by tablet computers. However, the creation of such electronic publications has generally required content editors to engage in a manual process of manipulating configuration files in order to determine the order and layout of content on pages of the electronic publication. Such an approach is difficult to scale given the various kinds and availability of content and does not lend itself to personalization of the electronic publication for a given user.

It is in this context that embodiments of the invention arise.

### SUMMARY

Broadly speaking, embodiments of the present invention provide methods and systems for layout determination for a content feed of various content items. Several inventive embodiments are described below.

In one embodiment, a method for determining the placement of content on a page is provided. The method initiates with receiving a content feed, the content feed including one or more content data items. One or more content viewer modules are selected for inclusion in the page, each content viewer module configured to present a content data item on the page. One or more page layouts are determined, each page layout defining one or more placement slots for placement of the content viewer modules. The selected content viewer modules are fitted to the page layouts to identify a valid page layout which can simultaneously accommodate each of the content viewer modules. The valid page layout is populated by assigning the content viewer modules to the placement slots of the valid page layout and applying the assigned content viewer modules to one or more of the content data items of the content feed.

In one embodiment, selecting the content viewer modules for inclusion in the page includes identifying a number of content viewer modules to include based on a position page number of the page.

In one embodiment, determining the page layouts includes selecting layouts having a number of placement slots equal to the identified number of content viewer modules to include.

In one embodiment, fitting the selected content viewer modules to the page layouts includes identifying an invalid page layout which cannot simultaneously accommodate each of the selected content viewer modules, and storing information identifying the combination of the invalid page layout and the selected content viewer modules.

In one embodiment, fitting the selected content viewer modules to a given page layout includes determining a priority of the selected content viewer modules for fitting based on one or more placement requirements associated with the selected content viewer modules.

In one embodiment, the content data items include one or more of text data, graphic data, audio data, or video data.

In another embodiment, a tangible computer readable medium having program instructions embodied thereon for determining the placement of content on a page is provided. The tangible computer readable medium includes: program instructions for receiving a content feed, the content feed including one or more content data items; program instructions for selecting one or more content viewer modules for inclusion in the page, each content viewer module configured to present a content data item on the page; program instructions for determining one or more page layouts, each page layout defining one or more placement slots for placement of the content viewer modules; program instructions for fitting the selected content viewer modules to the page layouts to identify a valid page layout which can simultaneously accommodate each of the content viewer modules; program instructions for populating the valid page layout by assigning the content viewer modules to the placement slots of the valid page layout and applying the assigned content viewer modules to one or more of the content data items of the content feed.

In another embodiment, a system for determining the placement of content on a page is provided. The system includes: a generator manager for receiving a content feed, the content feed including one or more content data items; a viewer generator for selecting one or more content viewer modules for inclusion in the page, each content viewer module configured to present a content data item on the page; a layout generator for determining one or more page layouts, each page layout defining one or more placement slots for placement of the content viewer modules; a fitting module for fitting the selected content viewer modules to the page layouts to identify a valid page layout which can simultaneously accommodate each of the content viewer modules; a renderer for populating the valid page layout by assigning the content viewer modules to the placement slots of the valid page layout and applying the assigned content viewer modules to one or more of the content data items of the content feed.

Other aspects of the invention will become apparent from the following detailed description, taken in conjunction with the accompanying drawings, illustrating by way of example the principles of the invention.

### BRIEF DESCRIPTION OF THE DRAWINGS

The invention may best be understood by reference to the following description taken in conjunction with the accompanying drawings in which:

FIG. 1 conceptually illustrates the assembly of a page of content, in accordance with an embodiment of the invention.

FIG. 2 illustrates a method for generating a page of content, in accordance with an embodiment of the invention.

FIG. 3 illustrates a system for generating pages of content, in accordance with an embodiment of the invention.

FIG. 4 illustrates a category view of an online publication stand rendered on a tablet computer, in accordance with an embodiment of the invention.

FIG. 5 illustrates a user's library view of an online publication stand, in accordance with an embodiment of the invention.

FIG. 6 illustrates a view of a page from an electronic publication, in accordance with an embodiment of the invention.

FIG. 7 illustrates an embodiment of a general computer system.

### DETAILED DESCRIPTION

The following embodiments describe systems and methods for determining the layout of content items from a content feed. It will be obvious, however, to one skilled in the art, that the present invention may be practiced without some or all of these specific details. In other instances, well known process operations have not been described in detail in order not to unnecessarily obscure the present invention.

A feed of data can include varying forms of content, such as text, images, and video, from various providers. The embodiments of the present invention provide methods and systems to determine the layout of such content onto pages, ensuring a balanced mixture of content with appropriate placement of ads. The present disclosure describes systems and logic employed to deliver a personalized content-viewing experience to viewers of an electronic publication.

An electronic publication may broadly be defined to organize and personalize content feeds to which users have subscribed or in which users may be otherwise interested. These feeds are presented in a stylized format to the user to make the content more appealing to view. Prior methods have required content editors to manually define how content and layouts are connected to each other, resulting in overall scalability and efficiency issues.

Broadly speaking, a system in accordance with embodiments of the invention may include the following: indexers to make sense of the raw feed data; themes to provide a common set of stylized layouts; templates which accept content, and are assigned to slots within the theme layout; and a rule and scoring engine that ties these components together to generate a coherent page that is consistent with the kind of content the user wishes to be delivered to her/him.

For purposes of clarity in understanding the present disclosure, reference will be made to the following concepts and objects, which can be defined by various metadata files.

A feed is a grouping of data, generally returned from the results of a relational database query. Feeds can include any of a broad variety of content types. Merely by way of example, feeds may range from tweets of a particular Twitter topic to news articles found on website properties.

A theme is a basic unit of visual foundation, which is represented by numerous layouts.

Layouts define slots, to which templates are assigned for display of content.

Common theme metadata properties include, for example, the number of slots, the dimensions of each slot, the purpose of the layout (e.g. whether the layout is suitable for the first page/introduction), and if a slot is appropriate for ad placement.

Viewers display incoming content, and include one or more templates. A viewer may be created for showing videos, displaying twitter feeds, displaying blog posts, etc. A viewer essentially handles and renders the fields from incoming feed data.

Common viewer metadata properties include, for example, acceptable types of feed content (e.g. viewer may only accept video content), and an available list of templates and their properties.

A viewer may contain one or more templates. While viewers are generally defined to perform business logic for handling feed data, templates define the actual formatting of the content for rendering.

Content can be rendered in an application or publication as part of a section. A section is a set of pages that is visualized with a consistent theme, whereas those themes contain a collection of layouts. Layouts are defined by the number of columns and rows, or slots to render. Each slot is associated with a viewer, which has a set of templates, where specific content from feeds are rendered.

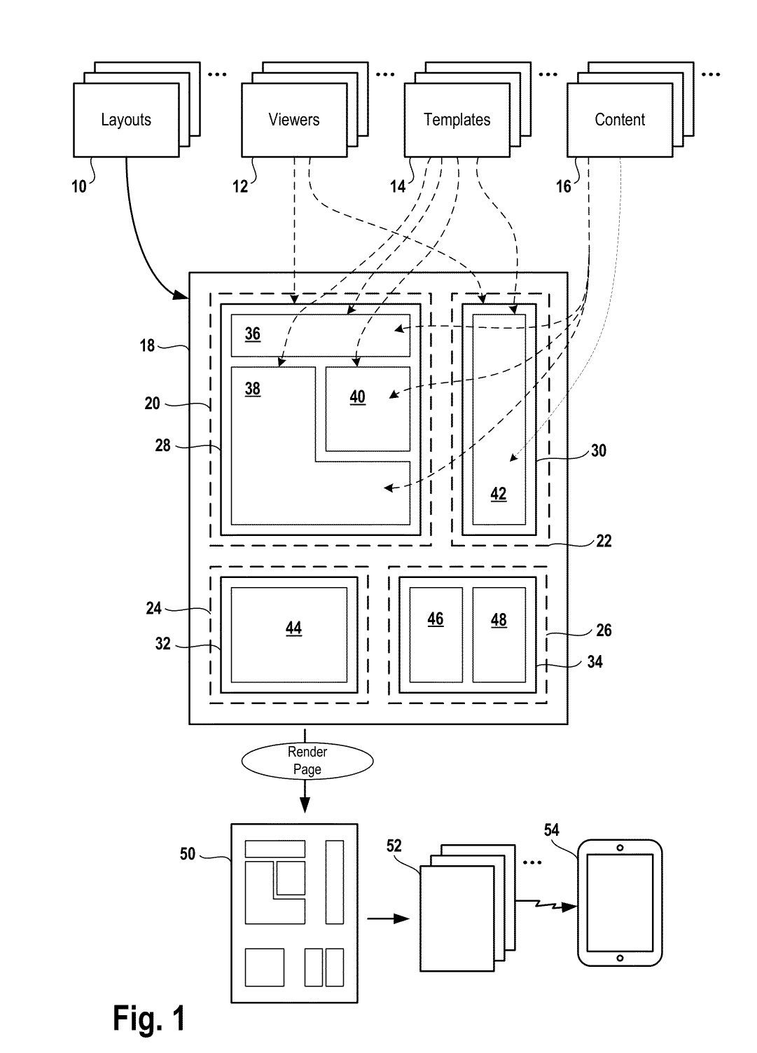

FIG. 1 conceptually illustrates the assembly of a page of content, in accordance with an embodiment of the invention. As shown, a layout 18 is selected from a plurality of layouts 10. The layout 18 includes several slots 20, 22, 24, and 26. The slots of the layout 18 are predefined for presentation of content via selected viewers. Each slot may have various defined characteristics, such as its dimensions, whether the slot is appropriate for placement of an advertisement, and other characteristics. As has been noted, a given layout may be part of a larger theme, the theme being defined by a number of layouts that have been designed or groups together to provide a consistent look and feel.

A viewer is selected from the plurality of viewers 12 for each of the slots of the layout 18. In the illustrated embodiment, a viewer 28 is assigned to the slot 20, a viewer 30 is assigned to the slot 22, a viewer 32 is assigned to the slot 24, and a viewer 34 is assigned to a slot 26. A viewer can include one or more templates from a plurality of templates 14 which define the formatting of content for display on the page. A given piece of content may include multiple subitems of content. By way of example, an article might include a headline, a picture, and a body of text. With reference to the illustrated figure, in accordance with one embodiment, the viewer 28 includes a template 36 for presentation of the headline portion of the article, a template 44 presentation of the picture portion of the article, and a template 38 for presentation of the body of text of the article.

As has been noted, a viewer can be defined to include business logic which affects the way in which content can be presented through the viewer. For example a viewer may be defined to have any of various types of requirements, such as the types of content it can accept, placement requirements affecting its placement on a given content page, sizing requirements, or any other kind of requirement which can be defined to place requirements on a given viewer. A few illustrative examples will serve to highlight the many possibilities which may be defined for the business logic of a given viewer. For example, it may not be desirable to provide certain kinds of content alongside or in close proximity to other specific kinds of content, which may be in accordance with a service level agreement or other type of business arrangement. Therefore, a viewer can optionally define that it cannot be placed alongside or on the same content page as another specified type of content or viewer, such as an advertisement or the same type of content or viewer, for example. As another example of a requirement which may be defined for a viewer, a viewer might specify a minimum size requirement of a slot to which it can be assigned, and/or specify a particular portion of the content page that it should occupy (e.g. top, left, right, bottom, etc.). Such a viewer may thus guarantee that the presentation of its content will occupy a certain region of a content page. As yet another example, a specific viewer may define acceptable types of content that it is capable of rendering. For example, a viewer may specify that it can only accept video content. Or in another embodiment, a viewer may specify that it can only accept a particular combination of content, e.g. a body of text and an audio file. The foregoing examples of business logic requirements which may be defined by a given viewer are provided merely by way of example, and not by way of limitation. It will be apparent to those skilled in the art that in various other embodiments, the viewer may define any of various kinds of business logic requirements that serve to specialize or otherwise define the manner in which a viewer can be applied for the presentation of content on a content page.

Additionally, a viewer can define a list of available templates and the properties of the available templates for formatting and presentation of content. A viewer may define more than one type of template to accommodate multiple types of content. Also, a viewer may simultaneously apply multiple templates within a given slot to which the viewer has been assigned. This may be especially useful when a particular piece of content includes several subitems of content, as has been mentioned above.

With continued reference to FIG. 1, the viewer 30 assigned to slot 22 includes template 42 from the plurality of templates 14, whereas the viewer 32 assigned to slot 24 includes a template 44, and the viewer 34 assigned to slot 26 includes templates 46 and 48. The illustrated arrangement of slots, viewers, and templates, on a given content page, is provided merely by way of example, and not by way of limitation. It will be apparent to those skilled in the art that in various embodiments, there may be any arrangement of slots on a content page and associated viewers and templates.

The templates of the various viewers are populated with content pieces from the content feed 16 to render a content page 50. The content page 50 may be part of a section of pages 52, that in one embodiment, define a portion of an electronic publication. The section of pages 52 can be transmitted for rendering on a computing device 54, such as a tablet computer or other computing device, having a display 56 or other hardware for rendering content.

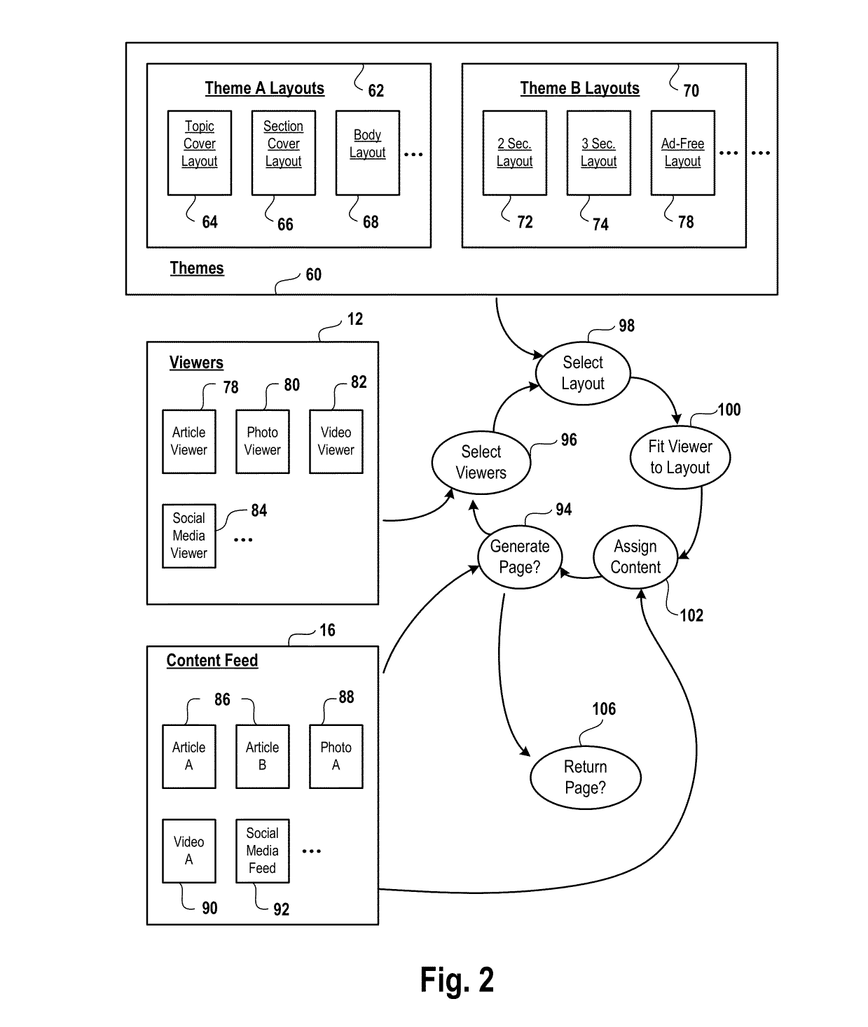

FIG. 2 illustrates a method for generating a page of content, in accordance with an embodiment of the invention. Broadly speaking, the method entails determination of appropriate viewers and a specific layout for at least some of the content in a content feed. The selected combination of viewers and the layout is validated, and if they pass validation, then content items are assigned to generate a page of content. The page generation process is repeated until a stop condition is reached, and the various generated pages are collected to form a section of pages for delivery to a user.

As shown, the content feed 16 includes various content items such as an article 86, a photo 88, a video 90, a social media feed 92 which includes data from a social network, etc. A pool of viewers 12 includes an article viewer 78, a photo viewer 80, a video viewer 82, a social media viewer 84, etc. A number of themes 60 are provided, including by way of example, a theme A (reference 62) and a theme B (reference 70). Theme A includes various layouts, such as a topic cover layout 64, a section cover layout 66, a body layout 68, etc. Theme B as shown includes a two-section layout 72, a three-section layout 74, an advertisement-free layout 76, etc.

At operation 94, it is determined whether or not to initiate or continue the process of generating a page. This may be based on various checks to determine that a page can be generated and that it is appropriate to do so in the present instance. These checks may take the form of stop conditions, for which when the stop condition is met, then the process of page generation is stopped. For example, in one embodiment, a page is not generated unless a number of available content items which have not already been assigned to a page is not zero. In another embodiment, a page is not generated if the number of pages which have already been generated has exceeded a predefined maximum number of pages. In one embodiment, a page is not generated unless the page generation process has not exceeded a specified maximum number of iterations. By way of example, the maximum number of iterations for the page generation process could be based on the maximum number of pages to be generated, e.g. the maximum number of iterations equals the maximum number of generated pages multiplied by a factor of two. In still other embodiments, the determination of whether or not to initiate or continue generation of pages can be based on a combination of data points. For example, the page generation process may continue if the current page to be generated has not exceeded 10 iterations and the amount of available content items is greater than three. In yet another embodiment, if there are no more viewers to possibly use with the remaining set of content items, then the page generation process is ended.

It will be appreciated that if the page generation process is stopped, then the current set of generated pages is returned at operation 106. The set of returned pages may define a section of an electronic publication that has been tailored for a specific user. Therefore, in one embodiment, the section of pages that has been generated is cached for a specified amount of time, so that subsequent requests for the section can be retrieved from cache without initiating another page generation process.

After passing the criteria for initiation of page generation at operation 94, then at operation 96 one or more viewers are selected from a plurality of viewers 12. Initially, all available viewers are queued for use. Then based on various optimization techniques and requirements, the number of viewers to be used is reduced to arrive at a selected group of viewers that will be fitted to a layout. By way of example, in one embodiment if it is determined that a cover page is to be used for the section for which pages are being generated, and it is the first page that is currently being generated, then only a single viewer is selected. Naturally, selection of only one viewer will eventually result in selection of a single slot layout, in accordance with methods described below. In one embodiment, if it is determined that it is the second page or beyond of a section that is being generated, then various considerations are applied. For example, it may be determined whether or not the page will contain an advertisement that is tied to a particular location within the page. If this is the case, then viewers that are also tied to the same location cannot be used and are therefore removed from consideration. In another embodiment, if more than three viewers are available for use, then the number of viewers is randomly reduced until the number of available viewers is three. In one embodiment, as viewers are randomly eliminated from use for the current page, there may be special conditions to prevent elimination of a particular viewer. For example, it may be defined that an article viewer or an advertisement viewer are not to be eliminated during the random reduction of viewers.

In another embodiment, there may be special adjustments made for particular situations. For example, it may be specified that if it is the first attempt to generate a given page of content, and there are only an article viewer and an ad viewer, then another article viewer is utilized for the first attempt so as to result in selection of a three slot layout. Whereas on subsequent attempts, the process will continue with utilization of only the article viewer and the ad viewer so as to cause selection of a two slot layout. The overall final result of the viewers selection operation 96 is a list of viewers to use.

At operation 98 a list of layouts is selected from amongst the layouts of the various themes 60. To provide for a consistent look and feel for a section of content, the layouts for a given section are selected from amongst a plurality of layouts which define a particular theme. In one embodiment, a layout type can be specified based on the type of page that is being generated. For example, if the process is generating the first page of the first section of a particular publication, then it may be defined that a topic cover layout type is to be used. As another example, if the process is generating the first page of a section beyond the first section then it may be specified that a section cover layout type is to be used. Based on the type of layout and the number of viewers that is to be utilized, a list of layouts that match these criteria is determined (i.e. layouts of the specified type having a slot count equal to the number of viewers).

Next at operation 100, the selected viewers are fitted to each of the possible layouts under consideration. Initially, it is determined which viewers can fit into which slots of each layout. If a given layout cannot support all of the viewers, then the layout is removed from consideration. Furthermore, the incompatible layout and viewer combination is marked so that it is not reused in future iterations. Metadata is generated describing which viewers can occupy which slots of each layout. Then for the remaining potential layouts under consideration, the fitting process entails selecting a random layout, and for each slot in that layout, determining which viewer to place into a particular slot based on the previously generated metadata. Viewers which can only occupy a specific slot are given priority over viewers which can occupy multiple slots. The resultant output of the viewer fitting operation 100 is the identification of a selected layout to be used and the viewers to use in each slot of the selected layout.

At operation 102, content items are assigned to each of the slots of the selected layout. This is accomplished by determining for each slot one or more templates based on the viewers assigned to the slot, and selecting content items to assign/commit to the slot. The new page is stored. If for some reason it is not possible to assign a template, then the layout is added to the incompatible layout and viewer combination list, and the procedure continues at operation 94, wherein it is determined whether to generate another page.

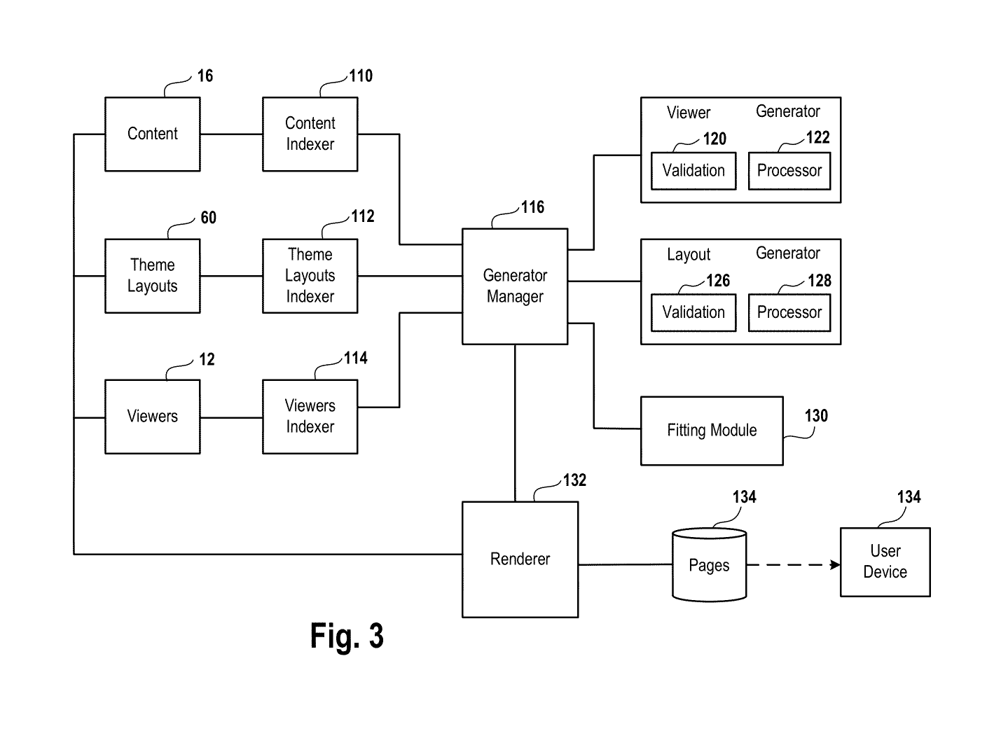

FIG. 3 illustrates a system for generating pages of content, in accordance with an embodiment of the invention. The content feed 16 is indexed by a content indexer 110, which generates metadata for characterizing and referencing the content items within the content feed 16. The theme layouts 60 are indexed by a theme layout indexer 112, which generates metadata for characterizing and referencing the layouts associated with each of the various themes. Similarly, a viewer indexer 114 indexes the viewers 12 to generate metadata which characterizes and references the viewers 12.

A generator manager 116 loads metadata indexes from the content indexer 110, the them layout indexer 112, and the viewer indexer 114, and also loads a viewer generator 118, a layout generator 124, and a fitting module 130. The generator manager 116 passes output of the viewer generator 118 to the layout generator 124, and passes output of the layout generator 124 to the fitting module 130.

The viewer generator 118 determines viewers to use for a page to be generated. The viewer generator 118 includes a validator 120 and a processor 122. The validator 120 performs checks such as ensuring that the number of available content items is not zero, or that the number of generated pages has not exceeded a predefine maximum, before proceeding. The processor 122 determines a set of viewers to use based on content items in the content feed 16.

The layout generator 124 determines possible layouts to use for the page to be generated. The layout generator 124 includes a validator 126 and a processor 128. The validator 126 may perform checks such as ensuring that layouts or templates have not been exhausted. The processor 128 determines a list of layouts having the appropriate number of slots for the set of viewers.

The fitting module 130 receives the set of viewers and the list of layouts to use for the page to be generated, and determines which viewers can fit into which slots of each layout. Layouts which cannot support all viewers are removed from consideration. From those layouts which can support all viewers, a single layout is selected and the viewers are assigned to the layout's slots. The output of the fitting module 130 is the layout to be used and the viewers to use with each slot of the layout.

The output from the fitting module 130 is passed to a rendering module 132 which assigns content items from the content feed 16 to the selected layout and viewers to generate the page of content. The generated page of content is stored in a page storage 134, and eventually transmitted, possibly as part of a section of pages, to a user device 136.

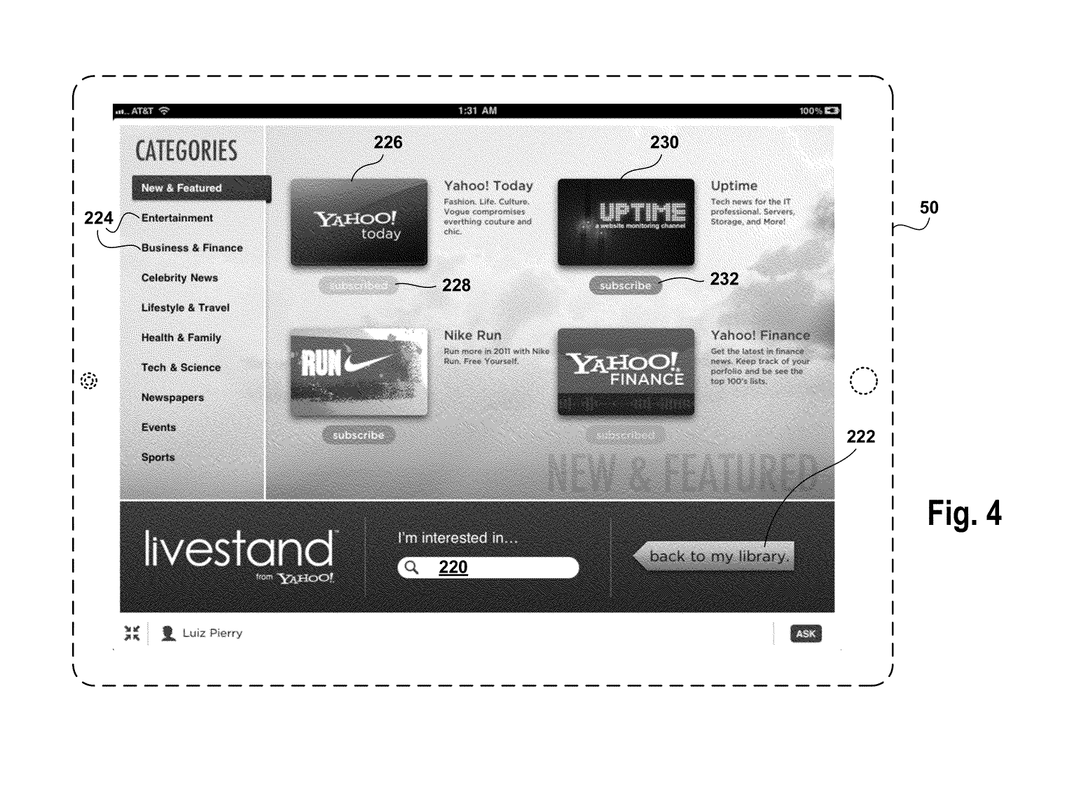

FIG. 4 illustrates a category view of an online publication stand rendered on a tablet computer 136, in accordance with an embodiment of the invention. A search box 220 is provided for enabling the user to search for electronic publications, and a library button 222 is provided to enable the user to navigate to their library of publications. Various categories 224 of electronic publications are provided for the user to select and thereby access different types of publications. In the illustrated embodiment, the “New & Featured” category has been selected, and corresponding publications from the category are shown for selection. The publication 226 is shown with a button 228 indicating that the user is already subscribed to this publication. Whereas for publication 230, the button 232 can be selected by the user in order to subscribe to the publication 230.

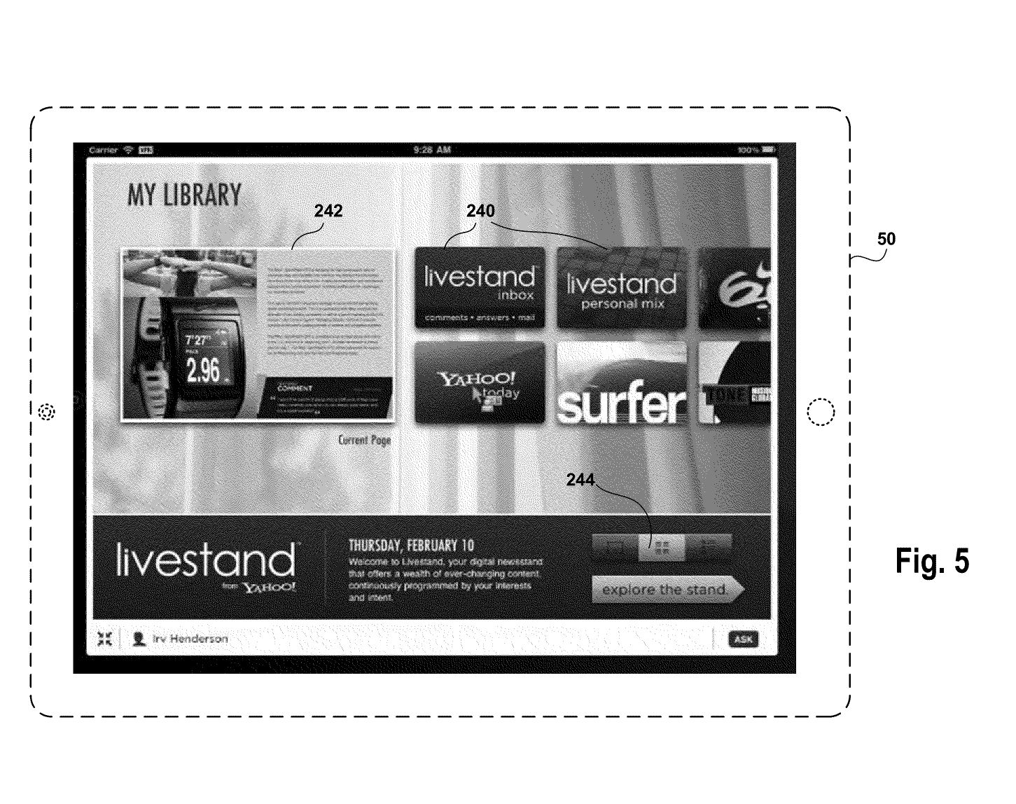

FIG. 5 illustrates a user's library view of an online publication stand, in accordance with an embodiment of the invention. The view of the user's library displays various publications 240 to which the user subscribes. Also, the view includes a current page 242 of a particular publication which the user last engaged with. A view toggle feature 244 enables the user to toggle between various levels of viewing from a single page view within a particular publication to a thumbnail view of the publications in the user's library.

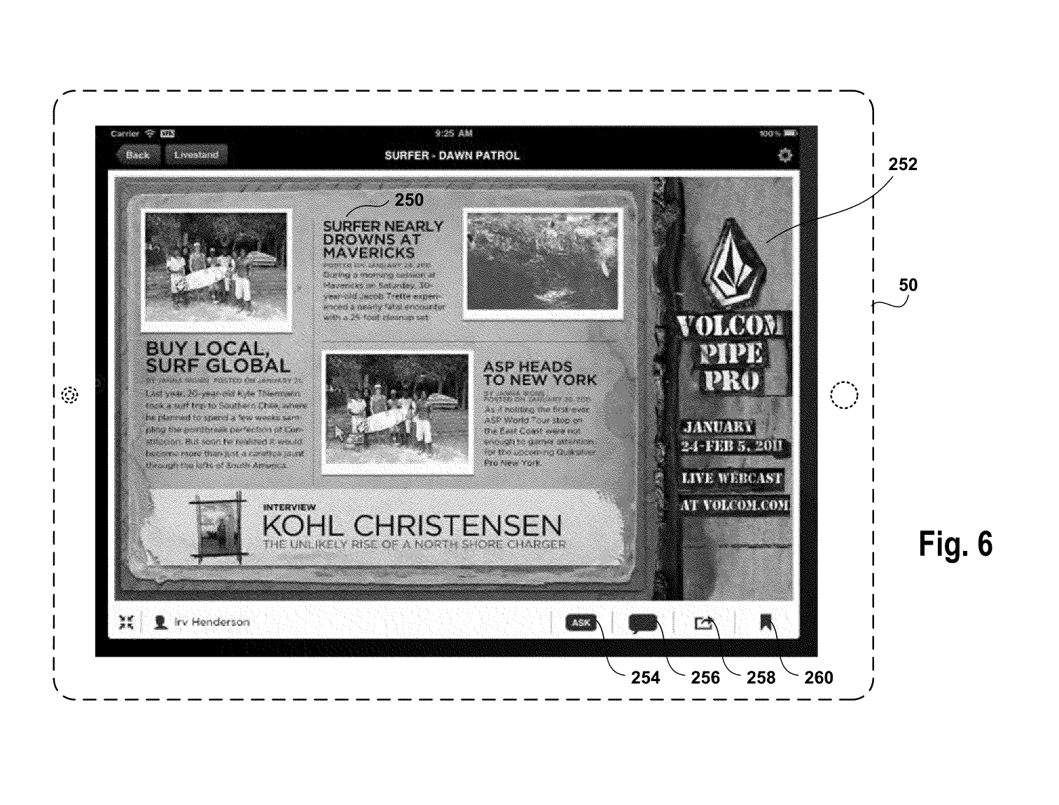

FIG. 6 illustrates a view of a page from an electronic publication, in accordance with an embodiment of the invention. As shown, the page includes vignettes 250 of articles included in the publication. Additionally, a display advertisement 252 is shown on the page. Several options buttons are shown at the bottom of the page. An ask button 254 provides access to help options, such as a help search function or a help menu. A comment button 256 enables the user to access and post comments relating to the electronic publication or to specific articles. A share button 258 enables the user to share the page or an article via e-mail, on a social network, etc. And a bookmark button 260 enables the user to bookmark pages within the electronic publication.

Embodiments of the invention herein described may utilize relational database systems as are known in the art. Examples of such database systems include MySQL, Oracle, and Access. Various operations as described above may be effected by performance of an operation via a relational database management system. Such database systems may be embodied in one or more server computers, which may be configured as part of a network of computers.

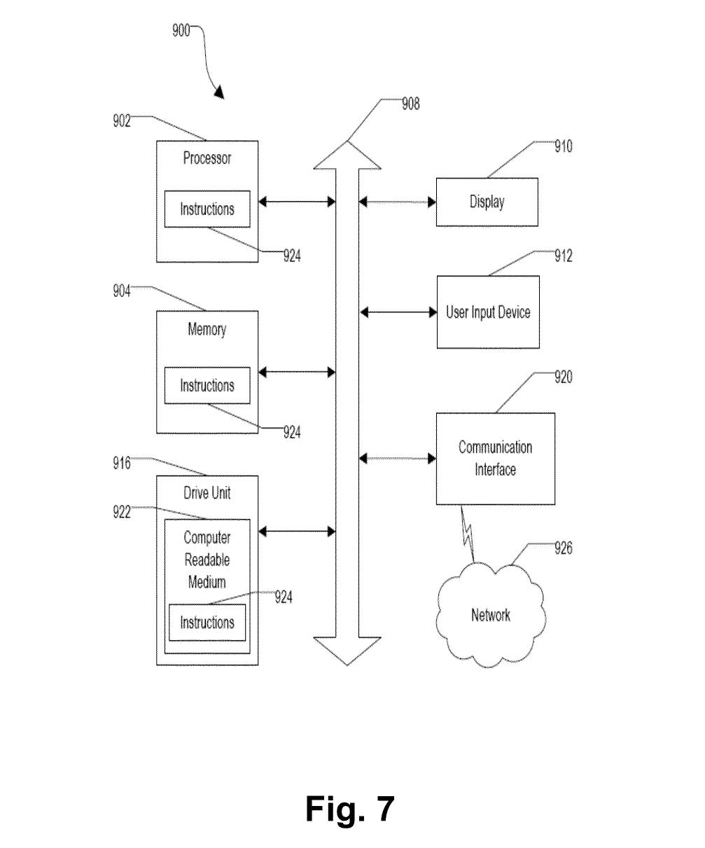

FIG. 7 illustrates an embodiment of a general computer system designated 900. The computer system 900 can include a set of instructions that can be executed to cause the computer system 900 to perform any one or more of the methods or computer based functions disclosed herein. The computer system 900 may operate as a standalone device or may be connected, e.g., using a network, to other computer systems or peripheral devices.

In a networked deployment, the computer system 900 may operate in the capacity of a server or as a client user computer in a server-client user network environment, or as a peer computer system in a peer-to-peer (or distributed) network environment. The computer system 900 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 900 can be implemented using electronic devices that provide voice, video or data communication. Further, while a single computer system 900 is illustrated, the term “system” shall also be taken to include any collection of systems or sub-systems that individually or jointly execute a set, or multiple sets, of instructions to perform one or more computer functions.

As illustrated in FIG. 7, the computer system 900 may include a processor 902, e.g., a central processing unit (CPU), a graphics processing unit (GPU), or both. The processor 902 may be a component in a variety of systems. For example, the processor 902 may be part of a standard personal computer or a workstation. The processor 902 may be one or more general processors, digital signal processors, application specific integrated circuits, field programmable gate arrays, servers, networks, digital circuits, analog circuits, combinations thereof, or other now known or later developed devices for analyzing and processing data. The processor 902 may implement a software program, such as code generated manually (i.e., programmed).

The computer system 900 may include a memory 904 that can communicate via a bus 908. The memory 904 may be a main memory, a static memory, or a dynamic memory. The memory 904 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 904 includes a cache or random access memory for the processor 902. In alternative embodiments, the memory 904 is separate from the processor 902, such as a cache memory of a processor, the system memory, or other memory. The memory 904 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 904 is operable to store instructions executable by the processor 902. The functions, acts or tasks illustrated in the figures or described herein may be performed by the programmed processor 902 executing the instructions stored in the memory 904. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing and the like.

As shown, the computer system 900 may further include a display unit 910, such as a liquid crystal display (LCD), an organic light emitting diode (OLED), a flat panel display, a solid state display, a cathode ray tube (CRT), a projector, a printer or other now known or later developed display device for outputting determined information. The display 910 may act as an interface for the user to see the functioning of the processor 902, or specifically as an interface with the software stored in the memory 904 or in the drive unit 916.

Additionally or alternatively, the computer system 900 may include an input device 912 configured to allow a user to interact with any of the components of system 900. The input device 912 may be a number pad, a keyboard, or a cursor control device, such as a mouse, or a joystick, touch screen display, remote control or any other device operative to interact with the computer system 900.

The computer system 900 may also or alternatively include a disk or optical drive unit 916. The disk drive unit 916 may include a computer-readable medium 922 in which one or more sets of instructions 924, e.g. software, can be embedded. Further, the instructions 924 may embody one or more of the methods or logic as described herein. The instructions 924 may reside completely or partially within the memory 904 and/or within the processor 902 during execution by the computer system 900. The memory 904 and the processor 902 also may include computer-readable media as discussed above.

In some systems, a computer-readable medium 922 includes instructions 924 or receives and executes instructions 924 responsive to a propagated signal so that a device connected to a network 926 can communicate voice, video, audio, images or any other data over the network 926. Further, the instructions 924 may be transmitted or received over the network 926 via a communication port or interface 920, and/or using a bus 908. The communication port or interface 920 may be a part of the processor 902 or may be a separate component. The communication port 920 may be created in software or may be a physical connection in hardware. The communication port 920 may be configured to connect with a network 926, external media, the display 910, or any other components in system 900, or combinations thereof. The connection with the network 926 may be a physical connection, such as a wired Ethernet connection or may be established wirelessly as discussed below. Likewise, the additional connections with other components of the system 900 may be physical connections or may be established wirelessly. The network 926 may alternatively be directly connected to the bus 908.

While the computer-readable medium 922 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding or carrying a set of instructions for execution by a processor or that cause a computer system to perform any one or more of the methods or operations disclosed herein. The computer-readable medium 922 may be non-transitory, and may be tangible.

The computer-readable medium 922 can include a solid-state memory such as a memory card or other package that houses one or more non-volatile read-only memories. The computer-readable medium 922 can be a random access memory or other volatile re-writable memory. Additionally or alternatively, the computer-readable medium 922 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The computer system 900 may be connected to one or more networks 926. The network 926 may be the same as, similar to, and/or in communication with networks 130 and/or 135. Any of networks 130, 135, and 926 may be wired or wireless. The wireless network may be a cellular telephone network, an 802.11, 802.16, 802.20, or WiMax network. Further, the networks 130, 135, and 926 may be a public network, such as the Internet, a private network, such as an intranet, or combinations thereof, and may utilize a variety of networking protocols now available or later developed including, but not limited to TCP/IP based networking protocols. The networks 130, 135, and 926 may include wide area networks (WAN), such as the Internet, local area networks (LAN), campus area networks, metropolitan area networks, a direct connection such as through a Universal Serial Bus (USB) port, or any other networks that may allow for data communication. The networks 130, 135, and 926 may be configured to couple one computing device to another computing device to enable communication of data between the devices. The networks 130, 135, and 926 may generally be enabled to employ any form of machine-readable media for communicating information from one device to another. The networks 130, 135, and 926 may include communication methods by which information may travel between computing devices. The network 130 may include the Internet and may include all or part of network 135; network 135 may include all or part of network 130. The networks 130, 135, and 926 may be divided into sub-networks. The sub-networks may allow access to all of the other components connected to the networks 130, 135 in the system 100, or the sub-networks may restrict access between the components connected to the networks 130, 135. The networks 130, 135, and 926 may be regarded as a public or private network connection and may include, for example, a virtual private network or an encryption or other security mechanism employed over the public Internet, or the like.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

What is claimed is:

1. A method for determining the placement of content on a page, comprising:
receiving a content feed, the content feed including one or more content data items;
selecting one or more content viewer modules for inclusion in the page, each content viewer module configured to present a content data item on the page;
determining one or more page layouts, each page layout defining one or more placement slots for placement of the content viewer modules;
fitting the selected content viewer modules to the page layouts to identify a valid page layout which can simultaneously accommodate each of the content viewer modules;
populating the valid page layout by assigning the content viewer modules to the placement slots of the valid page layout and applying the assigned content viewer modules to one or more of the content data items of the content feed.

2. The method of claim 1, wherein selecting the content viewer modules for inclusion in the page includes identifying a number of content viewer modules to include based on a position page number of the page.

3. The method of claim 2, wherein determining the page layouts includes selecting layouts having a number of placement slots equal to the identified number of content viewer modules to include.

4. The method of claim 1, wherein fitting the selected content viewer modules to the page layouts includes identifying an invalid page layout which cannot simultaneously accommodate each of the selected content viewer modules, and storing information identifying the combination of the invalid page layout and the selected content viewer modules.

5. The method of claim 1, wherein fitting the selected content viewer modules to a given page layout includes determining a priority of the selected content viewer modules for fitting based on one or more placement requirements associated with the selected content viewer modules.

6. The method of claim 1, wherein the content data items include one or more of text data, graphic data, audio data, or video data.

7. A tangible computer readable medium having program instructions embodied thereon for determining the placement of content on a page, including:
program instructions for receiving a content feed, the content feed including one or more content data items;
program instructions for selecting one or more content viewer modules for inclusion in the page, each content viewer module configured to present a content data item on the page;
program instructions for determining one or more page layouts, each page layout defining one or more placement slots for placement of the content viewer modules;
program instructions for fitting the selected content viewer modules to the page layouts to identify a valid page layout which can simultaneously accommodate each of the content viewer modules;
program instructions for populating the valid page layout by assigning the content viewer modules to the placement slots of the valid page layout and applying the assigned content viewer modules to one or more of the content data items of the content feed.

8. The tangible computer readable medium of claim 7, wherein selecting the content viewer modules for inclusion in the page includes identifying a number of content viewer modules to include based on a position page number of the page.

9. The tangible computer readable medium of claim 8, wherein determining the page layouts includes selecting layouts having a number of placement slots equal to the identified number of content viewer modules to include.

10. The tangible computer readable medium of claim 7, wherein fitting the selected content viewer modules to the page layouts includes identifying an invalid page layout which cannot simultaneously accommodate each of the selected content viewer modules, and storing information identifying the combination of the invalid page layout and the selected content viewer modules.

11. The tangible computer readable medium of claim 7, wherein fitting the selected content viewer modules to a given page layout includes determining a priority of the selected content viewer modules for fitting based on one or more placement requirements associated with the selected content viewer modules.

12. The tangible computer readable medium of claim 7, wherein the content data items include one or more of text data, graphic data, audio data, or video data.

13. A system for determining the placement of content on a page, comprising:
a generator manager for receiving a content feed, the content feed including one or more content data items;
a viewer generator for selecting one or more content viewer modules for inclusion in the page, each content viewer module configured to present a content data item on the page;
a layout generator for determining one or more page layouts, each page layout defining one or more placement slots for placement of the content viewer modules;
a fitting module for fitting the selected content viewer modules to the page layouts to identify a valid page layout which can simultaneously accommodate each of the content viewer modules;
a renderer for populating the valid page layout by assigning the content viewer modules to the placement slots of the valid page layout and applying the assigned content viewer modules to one or more of the content data items of the content feed.

14. The system of claim 13, wherein selecting the content viewer modules for inclusion in the page includes identifying a number of content viewer modules to include based on a position page number of the page.

15. The system of claim 14, wherein determining the page layouts includes selecting layouts having a number of placement slots equal to the identified number of content viewer modules to include.

16. The system of claim 13, wherein fitting the selected content viewer modules to the page layouts includes identifying an invalid page layout which cannot simultaneously accommodate each of the selected content viewer modules, and storing information identifying the combination of the invalid page layout and the selected content viewer modules.

17. The system of claim 13, wherein fitting the selected content viewer modules to a given page layout includes determining a priority of the selected content viewer modules for fitting based on one or more placement requirements associated with the selected content viewer modules.

18. The system of claim 13, wherein the content data items include one or more of text data, graphic data, audio data, or video data.
